(19) United States
(12) Patent Application Publication
(10) Pub. No.: US 2026/0370956 A1
(43) Pub. Date: Nov. 19, 2026

(54) CONTROLLER, CONTROL METHOD AND EVENT-BASED VISION MODULE

(71) Applicant: Sony Semiconductor Solutions Corporation, Atsugi-shi, Kanagawa (JP)

(72) Inventors: Astrid PETITJEAN, Stuttgart (DE); Costantino COSENTINO, Stuttgart (DE)

(73) Assignee: Sony Semiconductor Solutions Corporation, Atsugi-shi, Kanagawa (JP)

(21) Appl. No.: 19/154,380

(22) PCT Filed: Feb. 14, 2024
(86) PCT No.: PCT/EP2024/053699

§ 371 Date: Aug. 7, 2025

(30) Foreign Application Priority Data
Feb. 15, 2023 (EP) 23156697.7

(51) Int. Cl. H04N 23/74; H04N 23/71; H04N 25/47

(52) U.S. Cl. CPC H04N 23/74; H04N 23/71; H04N 25/47

(57) ABSTRACT

A controller for an event-based vision module, the event-based vision module including a light source configured to emit light according to a light emission pattern and an event-based vision sensor configured to acquire event data, wherein the controller includes circuitry configured to: detect, based on obtained event data, a light pattern; compute at least one of a space-division or time division light emission pattern according to the detected light pattern for avoiding interference with the detected light pattern; and control the light source to emit light according to the computed light emission pattern.

### TECHNICAL FIELD

The present disclosure generally pertains to a control and a control method for an event-based vision module, and to an event-based vision module.

### TECHNICAL BACKGROUND

Generally, vision modules are known which use active-light to sense a scene (e.g., used for AR (“Augmented Reality”) applications).

It is known that active-light interference may occur when multiple active-light vision modules interact simultaneously in the same space such that, in some cases, a measurement quality may be reduced, or no measurement may be possible at all.

Synchronization schemes are known to coordinate the active-light emission of the different vision modules. For example, a synchronization via a physical connection is known which may be precise, fast, and robust, however, it may not be suitable for mobile applications due to the physical connection (e.g., a wired connection). Also, a synchronization via wireless communication technologies is known, which avoids the physical connection but may introduce some delay. Although there exist techniques for controlling active-light emission, it is generally desirable to improve the existing techniques.

### SUMMARY

According to a first aspect the disclosure provides a controller for an event-based vision module, the event-based vision module including a light source configured to emit light according to a light emission pattern and an event-based vision sensor configured to acquire event data, wherein the controller comprises circuitry configured to:
detect, based on obtained event data, a light pattern;
compute at least one of a space-division or time division light emission pattern according to the detected light pattern for avoiding interference with the detected light pattern; and
control the light source to emit light according to the computed light emission pattern.

According to a second aspect the disclosure provides a control method for an event-based vision module, the event-based vision module including a light source configured to emit light according to a light emission pattern and an event-based vision sensor configured to acquire event data, wherein the control method comprises:
detecting, based on obtained event data, a light pattern;
computing at least one of a space-division or time division light emission pattern according to the detected light pattern for avoiding interference with the detected light pattern; and
controlling the light source to emit light according to the computed light emission pattern.

According to a third aspect the disclosure provides an event-based vision module, comprising:
a light source configured to emit light according to a light emission pattern;
an event-based vision sensor configured to acquire event data; and
a controller including circuitry configured to:
   detect, based on obtained event data, a light pattern,
   compute at least one of a space-division or time division light emission pattern according to the detected light pattern for avoiding interference with the detected light pattern,
   control the light source to emit light according to the computed light emission pattern.

Further aspects are set forth in the dependent claims, the drawings and the following description.

### BRIEF DESCRIPTION OF THE DRAWINGS

Embodiments are explained by way of example with respect to the accompanying drawings, in which:

FIG. 1 schematically illustrates in a block diagram an embodiment of an electronic device including an event-based vision module;

FIG. 2 schematically illustrates in a block diagram an embodiment of an event pixel;

FIG. 3 schematically illustrates in FIG. 3A an embodiment of a temporal intensity-modulation of a light emission pattern, in FIG. 3B an embodiment of events generated by an event pixel based, and in FIG. 3C an embodiment of a temporal intensity-modulation of a light emission pattern;

FIG. 4 schematically illustrates in a block diagram an embodiment of a multi-agent environment;

FIG. 5 schematically illustrates in FIG. 5A an embodiment of an interference situation, and in FIG. 5B an embodiment of an interference situation;

FIG. 6 schematically illustrates in a flow diagram an embodiment of a control method;

FIG. 7 schematically illustrates in a block diagram in FIG. 7A an embodiment of an interruption sequence for checking a presence of interfering active-light, and in FIG. 7B an embodiment of an interruption sequence for checking a presence of interfering active-light;

FIG. 8 schematically illustrates in a flow diagram an embodiment of computing a space-division light emission pattern;

FIG. 9 schematically illustrates in a flow diagram an embodiment of computing a time-division light emission pattern;

FIG. 10 schematically illustrates in FIGS. 10A and 10B an embodiment of computing a time-division light emission pattern;

FIG. 11 schematically illustrates in a flow diagram an embodiment of computing a time-division light emission pattern;

FIG. 12 schematically illustrates an embodiment an embodiment of computing a time-division light emission pattern;

FIG. 13 schematically illustrates in a flow diagram an embodiment of computing a time-division light emission pattern;

FIG. 14 schematically illustrates an embodiment of a light (emission) pattern including control information; and

FIG. 15 schematically illustrates in a flow diagram an embodiment of a control method.

### DETAILED DESCRIPTION OF EMBODIMENTS

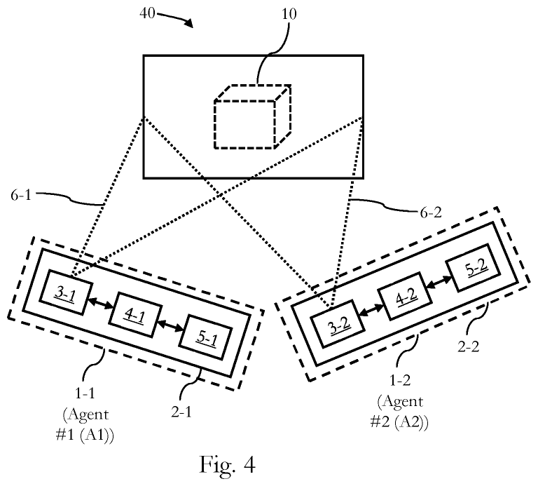

Before a detailed description of the embodiments under reference of FIG. 4 is given, general explanations are made.

As mentioned in the outset, generally, vision modules are known which use active-light to sense a scene (e.g., used for AR (“Augmented Reality”) applications).

As further mentioned in the outset, it is known that active-light interference may occur when multiple active-light vision modules interact simultaneously in the same space such that, in some cases, a measurement quality may be reduced, or no measurement may be possible at all.

It has been recognized that an event-based vision sensor should be used as a receiver to detect spatial and temporal presence of a light pattern which may cause interference, or which indicates the presence of interference, since it has been recognized that an event-based vision sensor provides high temporal resolution and low latency and detects changes of light intensities. This may allow to precisely detect interfering light.

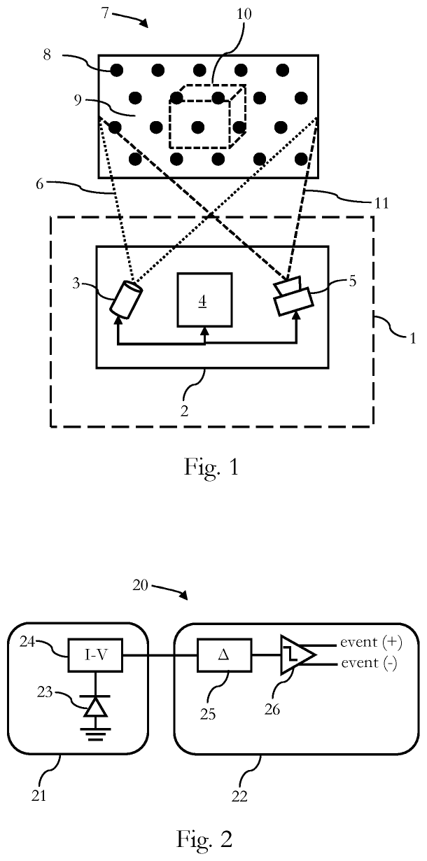

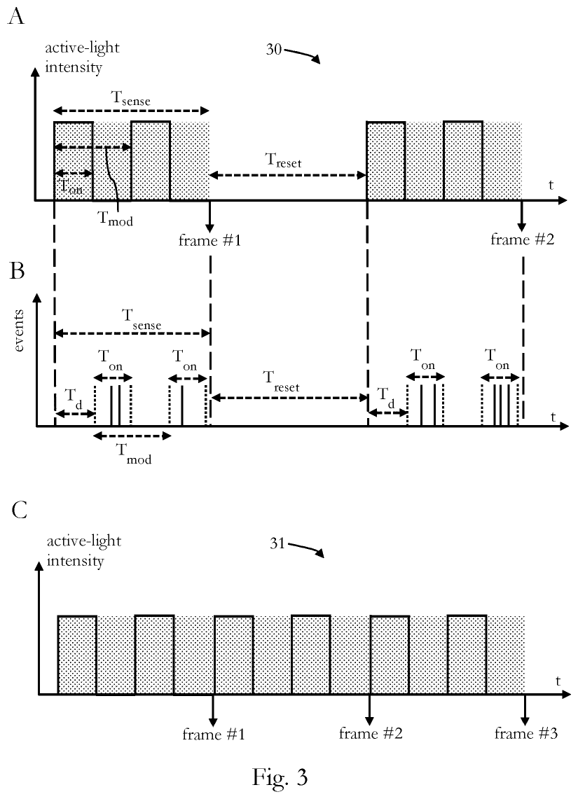

For enhancing the general understanding of the present disclosure, an embodiment of an electronic device 1 including an event-based vision module 2 is discussed in the following under reference of FIG. 1, FIG. 2 and FIG. 3, wherein the embodiment is also used in other embodiments of the present disclosure.

The electronic device 1 is a smartphone which runs an AR application and uses the event-based vision module 2 (EVM in the following) to sense a scene 7.

The EVM 2 includes a light source 3, a controller 4 and an event-based vision sensor 5 (EVS in the following).

The light source 3 includes an infrared laser diode array and optical parts such as a (adaptable) lens, a diffractive optical element, a color filter or the like.

The light source 3 emits light within a field-of-illumination 6 (FOI in the following) to the scene 7 according to a light emission pattern controlled by the controller 4, wherein the light emission pattern includes high intensity areas 8 (e.g., light spots) and low intensity areas 9.

The scene 7 includes an object 10 which at least partially reflects the light emission pattern.

The EVS 5 includes an array of event pixels and some optical parts such as a (adaptable) lens, a color filter or the like to image the reflected part of the light emission pattern within a field-of-view 11 (FOV in the following) on the array of event pixels.

An embodiment of an event pixel 20 is discussed in the following under reference of FIG. 2, which schematically illustrates in a block diagram the embodiment.

The event pixel 20 includes a pixel unit 21 and a luminance change detection unit 22.

The pixel unit 21 includes a photodiode 23 configured to perform photoelectric conversion on incident light, and a current-to-voltage converter 24 configured to convert the photocurrent from the photodiode 23 to a voltage.

The luminance change detection unit 22 includes a delta modulation circuit 25 configured to determine a difference between the voltage from the current-to-voltage generator and a reference voltage, and a comparator 26 configured to determine whether the difference exceeds either a plus or minus predetermined threshold and to generate either a plus event or minus event, respectively, when the plus or minus predetermined threshold is exceeded. The delta modulation circuit 25 is reset with the detected voltage as the reference voltage.

The generated event is asynchronously output as event data which include the event pixel coordinate (e.g., x and y position of the event pixel 20 in the array of event pixel), a generation time and the polarity information (plus or minus event).

In some embodiments, the event pixel 20 includes an adaptable high- and/or low-pass filter (not shown; e.g., an analog high- and/or low-pass filter) between the pixel unit 21 and the luminance change detection unit 22.

Returning to FIG. 1, as mentioned above, the light emission pattern includes high intensity areas 8 and low intensity areas 9 and, thus, it is spatial intensity-modulated.

The light emission pattern emitted by the light source 3 is further temporal intensity-modulated, as will be discussed in the following under reference of FIG. 3.

FIG. 3 schematically illustrates in FIG. 3A a first embodiment of a temporal intensity-modulation 30 of a light emission pattern, in FIG. 3B an embodiment of events generated by the event pixel 20, and in FIG. 3C a second embodiment of a temporal intensity-modulation 31 of a light emission pattern, which are discussed in the following.

Referring to FIG. 3A, a temporal intensity-modulation 30 of the light emission pattern is shown, which is emitted by the light source 3, and which includes a first pulse-width modulated signal during a time interval Tₛₑₙₛₑ (also referred to as sensing sequence in the following), a period with no light emission during a time interval Tᵣₑₛₑₜ in which the event pixel potentials are reset, and a second pulse-width modulated signal during a time interval Tₛₑₙₛₑ. This sequence may be repeated one or more times until sensing is stopped.

The first and second pulse-width modulated signals include high intensity periods during a time interval Tₒₙ and low (or no) intensity periods during a time interval T_{mod}−Tₒₙ subsequent to the high intensity period, wherein the modulation period T_{mod} corresponds to the time interval in which the high intensity periods and the low (or no) intensity periods are repeated within the sensing sequence.

During a sensing sequence, the EVS 5 is activated and generates events based on light incident onto the event pixels 20, as illustrated by the overlaid dot pattern during Tₛₑₙₛₑ.

At the end of each sensing sequence, a frame (#1 and #2) is output as event data by the EVS 5 to the control 4 which include the events asynchronously generated during the respective sensing sequence.

The inverse of the modulation period (T_{mod}) may be referred to as modulation frequency in the following.

The temporal capacity utilized by a light emission pattern is given by:

$$utilized temporal capacity = 100 \cdot \frac{{T}_{sense}}{{T}_{sense} + {T}_{reset}} \% .$$

The temporal intensity-modulation 30 shown in FIG. 3A has a utilized temporal capacity of 50% (and thus the corresponding light emission pattern) and the temporal intensity-modulation 31 shown in FIG. 3C has a utilized temporal capacity of 100% (and thus the corresponding light emission pattern).

The FIG. 3B schematically illustrates the events generated by the event pixel 20 based on incident light originating from a reflection of the light emission pattern emitted by the light source 3 at the object 10 in the scene 7, wherein the light emission pattern includes the temporal intensity-modulation 30.

During the first sensing sequence (corresponding to frame #1) the first events may be generated after a time interval T_{d}, which corresponds to the round-trip time of the light emitted by the light source 3 at the beginning of the first sensing sequence, reflected at object 10 and detected by the EVS 5 such that a depth value may be estimated based on T_{d}, since the control 4 knows the emission start timing of the sensing sequence.

The events illustrated with a dotted black line in FIG. 3B correspond to events generated due to the rising and falling edges of the temporal intensity-modulation 30 at the beginning and at the end of the time interval Tₒₙ. Hence, a sequence of plus and minus events is typically detected which corresponds to expected events due to the active-light.

The other events illustrated with a continuous black line correspond to events generated due to changes in the scene 7, e.g., due to movement of the object 10 or changes in reflectivity of the like such that these events may be used to interpret the scene 7.

It has been recognized that active-light of other agents may be detected and analyzed accordingly, in particular it may be computed whether the active-light of other agents may cause interference or has caused interference with the own active-light based on predetermined criteria.

Returning to the general explanations, in the following a “light pattern” corresponds to light present in a scene, e.g., due to active-light of other vision modules sensing at least a part of the same scene or due to ambient light or the like. Hence, the “light pattern” is an “external light pattern”. A “light emission pattern” corresponds to light that is emitted with some spatio-temporal characteristics by the light source of the own EMS.

Generally, a light emission pattern, as discussed herein, is characterized by a spatial intensity-modulation of the light emitted within the FOI (which may also be referred to as spatial intensity-modulated light signal), e.g., corresponding to the high intensity areas 8 and low intensity areas 9 (see, e.g., FIG. 1) and a temporal intensity-modulation (see, e.g., FIG. 3A) of the light emitted within the FOI 6 (which may also be referred to as temporal intensity-modulated light signal).

Thus, the light emission pattern includes a spatial intensity-modulated light signal and a temporal intensity-modulated light signal.

The spatial intensity-modulated light signal may include light spots, light stripes, a continuous spatial light intensity distribution such as Gaussian intensity distribution or the like.

The temporal intensity-modulated light signal may include a pulse-width modulation, e.g., with a rectangular or triangle shaped periods of high intensity and periods with low (or no) intensity.

As mentioned above, it has been recognized that an EVS should be used as a receiver to detect spatial and temporal presence of a light pattern which may cause interference, or which indicates the presence of interference, since it has been recognized that an EVS provides high temporal resolution and low latency and detects changes of light intensities. This may allow to precisely detect interfering light.

Moreover, it has been recognized that the EMS should be able to adapt its light emission without requiring synchronization signals from other agents, but rather to adapt it based on detecting the properties of the (external) light pattern of the other agent.

Hence, some embodiments pertain to a controller for an event-based vision module, the event-based vision module including a light source configured to emit light according to a light emission pattern and an event-based vision sensor configured to acquire event data, wherein the controller includes circuitry configured to:
detect, based on obtained event data, a light pattern;
compute at least one of a space-division or time-division light emission pattern according to the detected light pattern for avoiding interference with the detected light pattern; and
control a light source to emit light according to the computed light emission pattern.

Some embodiments pertain to an event-based vision module, wherein the event-based vision module includes:
an event-based vision sensor configured to acquire event data;
a light source configured to emit light according to a light emission pattern; and
a controller including circuitry configured to:
   detect, based on the event data, a light pattern,
   compute at least one of a space-division or time-division light emission pattern according to the detected light pattern for avoiding interference with the detected light pattern,
   control the light source to emit light according to the computed light emission pattern.

The circuitry may be based on or may include or may be implemented by typical electronic components configured to achieve the functionality as described herein.

The circuitry may be based on or may include or may be implemented as integrated circuitry logic and the functionality may be implemented by software executed by a processor or the like. The circuitry may be based on or may include or may be implemented by a CPU (central processing unit), a microcontroller, an FPGA (field programmable gate array), an ASIC (application specific integrated circuit), a GPU (graphical processing unit), a DSP (digital signal processor) or the like.

The circuitry may be based on or may include or may be implemented in parts by typical electronic components and integrated circuitry logic and in parts by software.

The circuitry may include storage capabilities such as magnetic storage, semiconductor storage, etc. The circuitry may include a data bus for transmitting and receiving data and may implement corresponding communication protocols.

The circuitry may include one or more data bus to exchange data with at least the light source and the event image sensor. Data may further be exchanged via a data bus with devices external to the EVM.

The EVS may include an array of event pixels (e.g., event pixels in accordance with FIG. 2). The EVS may be a Dynamic Vision Sensor (DVS), an Asynchronous Time Based Image Sensor (ATIS) or a Dynamic and Active Pixel Vision Sensor (DAVIS). Moreover, the EVS may combine event detection and conventional frame-based image capturing. The EVS may include optical parts such as (adaptable and movable) lenses, one or more color filters or the like.

The light source may include one or more light emitting diodes, one or more laser diodes, an array of light emitting diodes, an array of laser diodes or the like. The light source may include optical parts such as (adaptable and movable) lenses, one or more color filters, one or more diffractive optical elements or the like.

The controller (the circuitry thereof) detects, based on obtained event data, a light pattern.

The light pattern may be detected when the obtained events in the event data have a specific temporal characteristic (at least in a part of the FOV, for example, when more than a predetermined number of event pixels generated events with a specific temporal characteristic).

For example, the generated events include at least a partially periodic sequence of plus and minus events indicating presence of a temporal intensity-modulated light signal of another agent.

The specific temporal characteristic may further correspond to a specific random occurrence statistic of the events indicating an interference of active-light (temporal intensity-modulated light signal) of another agent with the current light emission pattern.

The specific temporal characteristic may further correspond to a deviation from an expected sequence of events due to a temporal intensity-modulated light signal of another agent, wherein the expected sequence is based on the own light emission pattern emitted by the light source.

The specific temporal characteristic may further be a predetermined sequence of plus and minus events indicating control information of another agent.

Moreover, the light pattern may further be detected under the constraint that the temporal intensity-modulated light signal has a modulation frequency above a predetermined threshold to filter out ambient light (ambient light may thus not lead to a detection of a light pattern).

The controller (the circuitry thereof) computes at least one of a space-division or time-division light emission pattern according to the detected light pattern for avoiding interference with the detected light pattern.

The controller randomly or according to a preset strategy priority selects between a space-division or time-division strategy that is tried at first for avoiding interference with the light pattern.

In the space-division strategy, in some embodiments, the controller analyses the detected light pattern regarding a spatial overlap with the FOV of the EVM to compute an interference region in which interference may occur and to compute whether there is enough space left for sensing without interference.

When there is enough space for sensing without interference, in some embodiments, the controller computes the space-division light emission pattern accordingly and controls the light source to emit light according to the space-division light emission pattern.

The light source adjusts (under the control of the controller), in some embodiments, the FOI (if possible) accordingly, for example, by switching off laser diodes associated with the interference region or adjusting a movable lens to emit in a region of the scene other than the interference region.

Hence, in some embodiments, the space-division light emission pattern lets the light source emit light in a space-divisional manner with respect to the detected light pattern.

In the time-division strategy, in some embodiments, the controller analyses the detected light pattern regarding its temporal characteristics to compute the emission start timing and utilized temporal capacity of the light pattern to further compute whether there is enough temporal capacity left for sensing without interference.

When there is enough temporal capacity left for sensing without interference, in some embodiments, the controller computes the time-division light emission pattern accordingly and controls the light source to emit light according to the time-division light emission pattern.

The light source adjusts (under the control of the controller), in some embodiments, the emission start timing and the temporal capacity accordingly such that the sensing sequence falls within a time interval which is not utilized by the light pattern (e.g., where the light pattern has no sensing sequence).

Hence, in some embodiments, the time-division light emission pattern lets the light source emit light in a time-divisional manner with respect to the detected light pattern.

In some embodiments, the circuitry is configured to control, when no light pattern is detected, the light source to emit light according to a default light emission pattern.

In some embodiments, the circuitry is configured to compute whether interference with the light pattern is inevitable and to output, in response thereto, an instruction to move the field-of-view.

In some embodiments, the circuitry is configured to perform a communication protocol when a temporal capacity utilized by the detected light pattern is above a predetermined threshold.

In some embodiments, the communication protocol includes controlling the light source to emit light having a disturbance sequence light emission pattern for signaling a request for temporal capacity.

In some embodiments, the disturbance sequence light emission pattern includes a disturbance sequence including a temporal intensity-modulated light signal, wherein a modulation frequency of the temporal intensity-modulated light signal is higher than a modulation frequency of the detected light pattern. In some embodiments, the modulation frequency of the temporal intensity-modulated light signal is at least twice the modulation frequency of the detected light pattern.

Moreover, in some embodiments, the disturbance sequence light emission pattern utilizes 100% temporal capacity.

In some embodiments, the circuitry is configured to:
control the light source to stop light emission after emitting the disturbance sequence light emission pattern; and
start again, after controlling the light source to stop light emission, detection of the light pattern to compute whether the light pattern has changed to another light pattern or whether the light pattern has vanished.

In some embodiments, the communication protocol includes computing whether the light pattern includes a disturbance sequence, and wherein the circuitry is configured to start again, when the light pattern includes a disturbance sequence, detection of the light pattern to compute whether the light pattern has changed to another light pattern or whether the light pattern has vanished.

The computed disturbance sequence included in the light pattern includes, in some embodiments, a temporal intensity-modulated light signal, wherein a modulation frequency of the temporal intensity-modulated light signal is above a first predetermined threshold larger than a second predetermined threshold for detecting a mere presence of a light pattern. Moreover, in some embodiments, the disturbance sequence utilizes 100% temporal capacity.

In some embodiments, the circuitry is configured to control the light source to emit light having a control information light emission pattern for signaling control information about a current or next light emission pattern emitted by the light source.

In some embodiments, wherein detected light pattern includes control information about a current or next light pattern, and wherein the circuitry is configured to obtain the control information and to compute the time-division light emission pattern according to the obtained control information.

The control information include information about the temporal characteristics of the current and/or next light pattern or light emission pattern, wherein the information may include information about a current and/or next utilized temporal capacity, a sampling and/or measurement frequency, a sampling and/or measurement duration, a sampling and/or measurement pattern (e.g., in case of non-constant frequency), a time and/or duration until the next sensing sequence.

In some embodiments, the circuitry is configured to regularly perform the detection of the predetermined light pattern.

In some embodiments, the circuitry is configured to control the light source to stop emitting light during the detection of the predetermined light pattern.

In some embodiments, the circuitry is configured to control a detection time interval on a random basis.

In some embodiments, the circuitry is configured to control the light source to increase an output power and to control the EVS to increase plus and minus threshold values.

This strategy may allow to keep a good sensing quality for the EVM (e.g., as a last resort if FOI/FOV moving is no possible), however, it may reduce the sensing quality of other agents. This may also increase the risk of a deadlock.

In some embodiments, the circuitry is configured to control the event-based vision sensor to adapt a low-pass filter frequency to be lower than a modulation frequency of the light pattern.

In some embodiments, the circuitry is configured to control the light source to use a modulation frequency for the light emission pattern that is lower than the low-pass filter frequency.

Thereby, the light pattern may be filtered out such that only the own sensing light is detected.

It has been recognized that the event-response of the event pixels depends on a brightness or luminance or intensity of the light incident onto the event pixels

It has been recognized that, when multiple agents interact simultaneously in the same space, the brightness may change whenever there is interference.

Thus, it has been recognized that a change in latency of the event-response timing may be used to detect interference.

Hence, in some embodiments, the circuitry is configured to detect the light pattern further based on a change in latency of an event-response timing.

This may allow to compute an interference timing and offset and the interference region more precisely. Moreover, this may allow to obtain insights into the light pattern emitted by another agent, for example, the light emission power and color.

Application examples of the EVM include:

In smartphones with active-light sensing in a multi-agent environment in which each the active-light is used at the same time in the same space, for example, when playing a game (e.g., AR application).

In head-mounted displays (“HMDs”) with active-light in a multi-agent environment in which the HMDs have no centralized processor and in which each the active-light is used at the same time in the same space, for example, in a multi-player VR (“Virtual Reality”) game or with multiple MR (“Mixed Reality”) glasses in the same environment for hand gesture recognition in a meeting room with multiple HMD wearers.

In drones for drone inspection in a multi-drone environment in which each the active-light is used at the same time in the same space, for example, for inspection of large areas that may benefit from employing multiple drones (e.g., farming, factory, search and rescue, or the like).

Moreover, in drone inspection, a target (e.g., bicycle) may enter the FOV of the drone's EVS and the target has an LED marker applied on the back. The drone may stop scanning and detects a light communication protocol emitted by the markers. The drone may start following the target and equally divides the sensing capacity of the EVS for active sensing and LED light capture (motion segmentation).

Some embodiments pertain to a (corresponding) control method for an event-based vision module, the event-based vision module including a light source configured to emit light according to a light emission pattern and an event-based vision sensor configured to acquire event data, wherein the control method includes:
detecting, based on obtained event data, a light pattern;
computing at least one of a space-division or time-division light emission pattern according to the detected light pattern for avoiding interference with the detected light pattern; and
controlling a light source to emit light according to the computed light emission pattern.

The control method may be performed by the controller as described herein.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

Returning to FIG. 4, there is schematically illustrated in a block diagram an embodiment of a multi-agent environment 40 including a first electronic device 1-1 (Agent #1 (A1)) and a second electronic device 1-2 (Agent #2 (A2)).

The first electronic device 1-1 includes a first EVM 2-1 which includes a first light source 3-1, a first controller 4-1 and a first EVS 5-1. Generally, the first electronic device 1-1 is similar to the electronic device 1 of FIG. 1 and, thus, it is referred to the discussion of FIG. 1 above for the respective components (2-1 similar to 2, 3-1 similar to 3, 4-1 similar to 4, 5-1 similar to 5) to avoid unnecessary repetition of description.

The second electronic device 1-2 includes a second EVM 2-2 which includes a second light source 3-2, a second controller 4-2 and a second EVS 5-2. Generally, the second electronic device 1-2 is similar to the electronic device 1 of FIG. 1 and to the first electronic device 1-1 and, thus, it is referred to the discussion of FIG. 1 above for the respective components (2-2 similar to 2, 3-2 similar to 3, 4-2 similar to 4, 5-2 similar to 5) to avoid unnecessary repetition of description.

The first light source 3-1 may emit light according to a light pattern within a first FOI 6-1 and the second light source 3-2 may emit light according to a light emission pattern within a second FOI 6-2 to sense the object 10, wherein the first FOI 6-1 and the second FOI 6-2 overlap.

When both A1 and A2 emit light simultaneously to sense the object 10, there may occur interference which may reduce a sensing quality or even make it impossible to sense the object 10, in some cases.

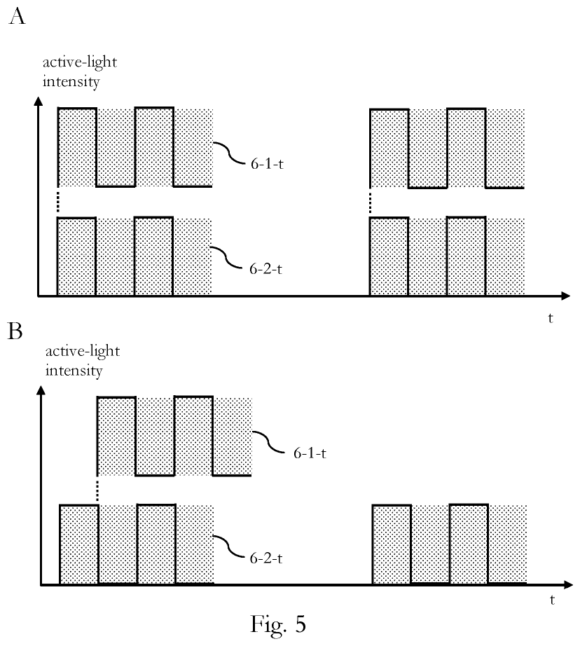

FIG. 5 schematically illustrates in FIGS. 5A and 5B two embodiments of interference situations which may occur, which are discussed in the following.

It is assumed that A1 and A2 sense the same space.

In FIG. 5A, a first temporal intensity-modulated light signal 6-1-t is depicted which is emitted by the first light source 3-1 within the first FOI 6-1, and a second temporal intensity-modulated light signal 6-2-t is depicted which is emitted by the second light source 3-2 within the second FOI 6-2.

In the case of FIG. 5A, each sensing sequence included in 6-1-t and 6-2-t occur at the same time resulting in a phase difference of 0° and a higher intensity present at the object 10 than in the case of only one agent.

This may result in more than expected events detected with each event image sensor 5-1 and 5-2 which may reduce a sensing quality, since it may be difficult to compute which events generated in a high intensity period are due to changes in the scene or due to the interference.

In the case of FIG. 5B, each sensing sequence included in 6-1-t is phase-shifted by 180° with respect to a corresponding sensing sequence included in 6-2-t.

This may result in a constant illumination power at the object 10 and may result in a temporal random occurrence statistic of detected events due to the rising and falling edges in each sensing sequence.

This may reduce a sensing quality, since it may be difficult to compute which events are due to changes in the scene and which are due to interference.

Other phase differences between the sensing sequences included in 6-1-t with respect to the sensing sequences included in 6-2-t may result in double periodic detection of events.

This may reduce a sensing quality, since it may be difficult to compute which events are due to changes in the scene and which are due to interference.

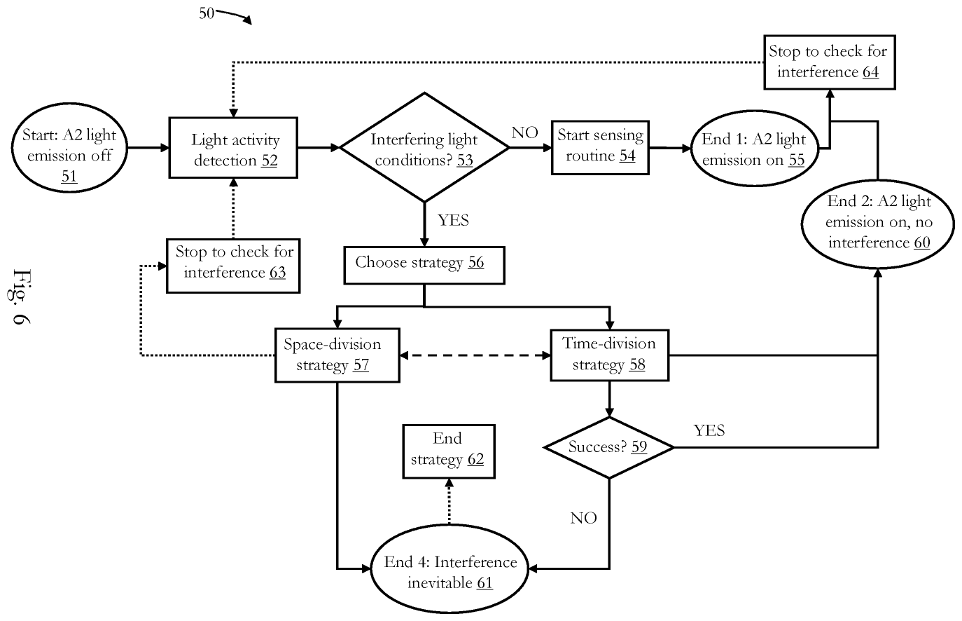

An embodiment of a control method 50 for avoiding interference between the two agents A1 and A2 is discussed in the following under reference of FIG. 6, which schematically illustrates the control method 50 in a flow diagram.

The control method 50 is performed by the second controller 4-2 of the second agent A2.

At 51, the second agent A2 has turned its light emission off.

At 52, the second controller 4-2 controls the second EVS 5-2 to acquire event data and obtains the event data from the second EVS 5-2 and, thus, starts and performs light activity detection.

At 53, the second controller 4-2 detects, based on the obtained event data, a light pattern. In other words, the second control 4-2 computes whether there are light conditions present which may result in an interference with the own sensing light.

At 54 and 55, when no light pattern is detected, the second control 4-2 controls the second light source 3-2 to emit light according to a default light emission pattern. The default light emission pattern may have, e.g., a temporal capacity utilization between 50-100%.

At 56, when a light pattern is detected, the second control 4-2 randomly or according to a preset strategy priority selects between a space-division or time-division strategy that is tried at first for avoiding interference with the detected light pattern.

The preset strategy priority may depend on the limitations of the EVM or a desired application.

For example, in the present case in which two agents perform 3D scanning and interact with the same space or object, a time-division strategy may be preferred over a space-division strategy. Both may be preferred further over a movement to change the FOV.

In another example in which a UAV (“unmanned aerial vehicle”) is autonomously inspecting a facility, it might be preferred to reduce its own FOV/FOI over reducing the temporal capacity which may further be preferred over a movement to change the FOV.

Any of the three strategies (time-division, space-division, movement) may be ordered differently depending on the final desired goal.

Moreover, any of the three strategies may not be available due to hardware limitations.

At 57, the second controller 4-2 tries a space-division strategy to compute a space-division light emission pattern, as will be discussed under reference of FIG. 8.

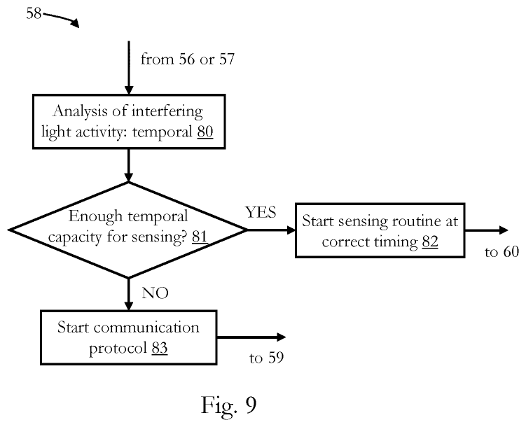

At 58, the second controller 4-2 tries a time-division strategy to compute a space-division light emission pattern, as will be discussed under reference of FIGS. 9 to 14.

At 59, the second controller 4-2 evaluates whether a communication protocol was successful.

When the second controller 4-2 has computed a time-division light emission pattern, at 58, the second controller 4-2 controls the light source to emit light according to the computed light emission pattern at 60.

Moreover, at 60, if the communication protocol was successful, the second controller 4-2 controls the light source to emit light according to the computed light emission pattern.

The dashed arrow between 57 and 58 indicates that the other strategy may be tried by the second controller 4-2 when the first selected strategy was unsuccessful or it may be tried in addition such that the light emission pattern lets the second light source 3-2 emit light in a space-divisional and time-divisional manner.

At 61, if the communication protocol was unsuccessful and the space-division strategy 57 also failed, the second controller 4-2 computes that interference is inevitable and initiates, at 62, an end strategy.

The end strategy, at 62, may include generating and outputting an instruction to move the FOV or may include an instruction to wait for a predetermined amount of time until the control method 50 is started again.

At 63 and 64, when at least one of a space-division or time-division light emission pattern has been computed and the second light source 3-2 emits light according to the computed light emission pattern, the second controller 4-2 regularly stops emitting light to check for possible interference light.

Generally, the interference check, or in other words the check for a light pattern, may happen continuously without stopping light emission, however, as mentioned above, it may be difficult for the second controller 4-2 to distinguish between normal changes of the event-response due to the interaction with the scene or changes of the event-response due to parasitic light.

Here, at 63 and 64, light emission is stopped for detecting a light pattern.

Generally, the second controller 4-2 regularly performs the detection of the light pattern at 63 and 64.

This regular check may be performed periodically with a constant detection time interval (check duration), for example, after each sensing sequence or after a predetermined number of sensing sequences.

These checks may be kept shortly and frequent, allowing to detect possible interfering light early on and the throughput frequency is constant.

In other embodiments, the checks may be performed regularly on a random basis, for example, after a random number of sensing sequences for a fixed duration, after a fixed number of sensing sequences for a random duration, or after a random number of sensing sequences for a random duration.

The checks on a random basis may lower the risk of a deadlock between the two agents. A deadlock is when agents involved are in the same stage at the exact same time.

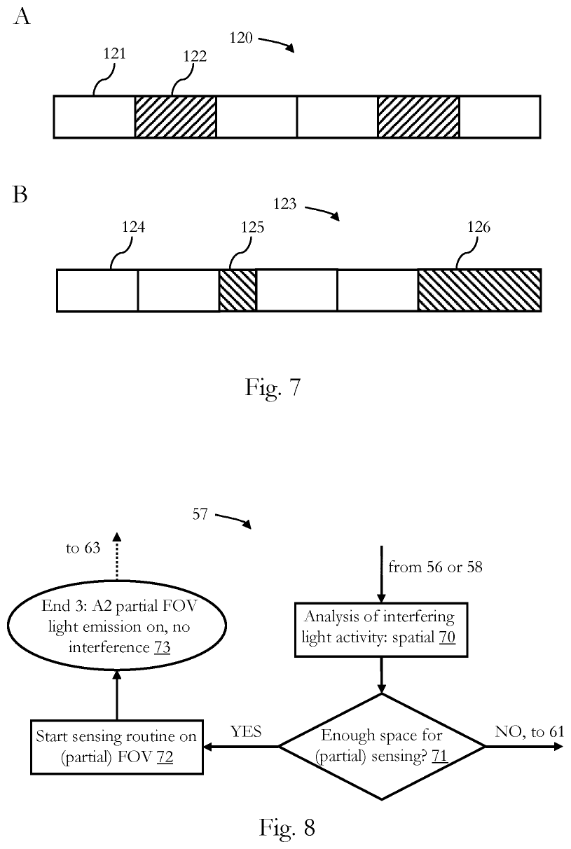

FIG. 7 schematically illustrates in a block diagram in FIG. 7A an embodiment of an interruption sequence 120 for checking a presence of interfering active-light, and in FIG. 7B an embodiment of an interruption sequence 123 for checking a presence of interfering active-light, which are discussed in the following.

The interruption sequence 120 includes sensing sequences 121 (white boxes) and detection time intervals 122 (striped boxes) in which the detection of a light pattern is performed, wherein the detection time intervals 122 each have the same duration and are inserted periodically after every two sensing sequences.

The interruption sequence 123 includes sensing sequences 124 (white boxes) and detection time intervals 125 (striped boxes) in which the detection of a light pattern is performed, wherein the detection time intervals 125 each have a random duration and are inserted periodically after every two sensing sequences.

FIG. 8 schematically illustrates in a flow diagram an embodiment of computing a space-division light emission pattern, which is discussed in the following under reference of FIGS. 6 and 8. The computing of a space-division light emission pattern is performed when the second controller 4-2 selects the space-division strategy 57.

At 70, the second controller 4-2 analyses the light pattern spatially. In other words, the second controller 4-2 performs a spatial analysis of interfering light activity.

The second controller 4-2 analyses the detected light pattern regarding a spatial overlap with the FOV of the second EVS 2-2 to compute an interference region in which interference may occur.

At 71, the second controller 4-2 computes whether there is enough space left for sensing without interference.

The second controller 4-2 computes that there is enough space for sensing without interference when a predetermined number of adjacent event pixels that detected the light pattern is below a predetermined threshold, e.g., the predetermined number of adjacent event pixels may represent 50% of the total number of event pixels.

If YES at 71:

At 72 and 73, the second controller 4-2 computes the space-division light emission pattern accordingly and controls the second light source 3-2 to emit light according to the space-division light emission pattern.

Hence, the space-division light emission pattern lets the second light source 3-2 emit light in a space-divisional manner with respect to the detected light pattern

For example, the second light source 3-2 adjusts (under the control of the second controller 4-2) the FOI accordingly, for example, by switching off laser diodes associated with the interference region or adjusting a movable lens to emit in a region of the scene other than the interference region.

If NO at 71:

The second controller 4-2 computes that interference is inevitable at 61 and initiates the end strategy 62.

FIG. 9 schematically illustrates in a flow diagram an embodiment of computing a time-division light emission pattern, which is discussed in the following under reference of FIGS. 6 and 9.

The computing of a time-division light emission pattern is performed when the second controller 4-2 selects the time-division strategy 58.

At 80, the second controller 4-2 analyses the light pattern temporal. In other words, the second controller 4-2 performs a temporal analysis of interfering light activity.

The second controller 4-2 analyses the detected light pattern regarding its temporal characteristics to determine the emission start timing and utilized temporal capacity of the light pattern.

At 81, the second controller 4-2 computes whether there is enough temporal capacity left for sensing without interference.

For example, the second controller 4-2 computes whether a utilized temporal capacity of the light pattern is below or above a predetermined threshold (e.g., 75%).

If YES at 81:

The second controller 4-2 computes the time-division light emission pattern accordingly and controls the second light source 3-2 to emit light according to the time-division light emission pattern at 82 and 60.

Hence, the time-division light emission pattern lets the second light source 3-2 emit light in a time-divisional manner with respect to the detected light pattern.

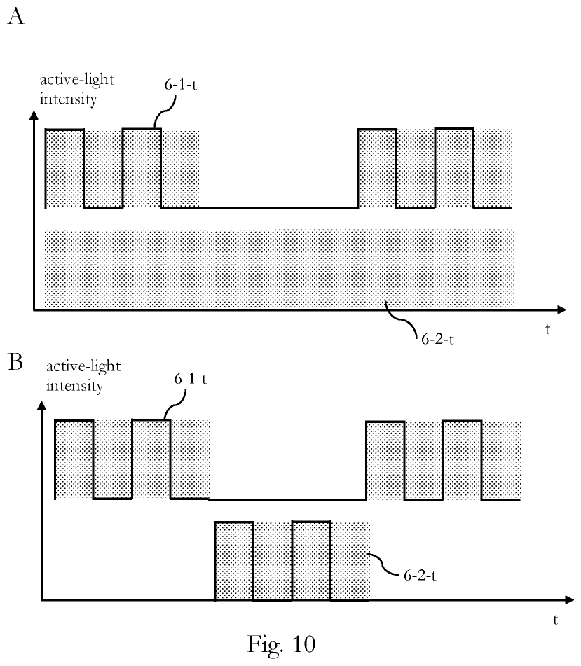

FIG. 10 schematically illustrates in FIGS. 10A and 10B an embodiment of computing a time-division light emission pattern, which is discussed in the following under reference of FIGS. 6, 9 and 10.

In FIG. 10A, a first temporal intensity-modulated light signal 6-1-t is depicted which is emitted by the first light source 3-1 within the first FOI 6-1.

The first temporal intensity-modulated light signal 6-1-t utilizes a temporal capacity of 50%.

The second controller 4-2 simultaneously performs light activity detection with no light emission (as illustrated by 6-2-t) and detects, based on event data generated during light activity detection, that a light pattern according to the first temporal intensity-modulated light signal 6-1-t is present.

Then, the second controller 4-2 computes, at 80, an emission start timing and a utilized temporal capacity of the first temporal intensity-modulated light signal 6-1-t, which is here computed to be 50%.

Accordingly, the second controller 4-2 computes, at 81, that there is enough temporal capacity left for sensing without interference.

Then, the second controller 4-2 computes the time-division light emission pattern accordingly and controls the second light source 3-2 to emit light according to the time-division light emission pattern at 82 and 60.

Hence, the time-division light emission pattern lets the second light source 3-2 emit light in a time-divisional manner with respect to the detected light pattern, as illustrated in FIG. 10B.

Thereby, the sensing sequences of the second agent A2 fall within a period in which the first agent has no sensing sequence and, thus, interference is avoided.

Returning to FIG. 9, if NO at 81:

The second controller 4-2 starts, at 83, to perform a communication protocol.

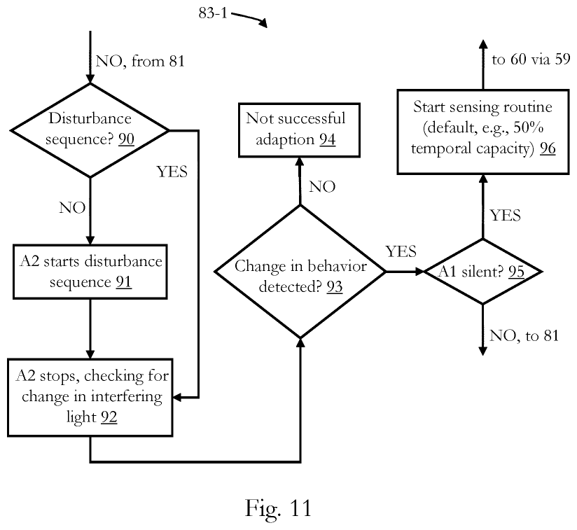

FIG. 11 schematically illustrates in a flow diagram an embodiment of computing a time-division light emission pattern according to a first communication protocol 83-1, which is discussed in the following under reference of FIGS. 6, 8 and 11.

If NO at 81:

The second controller 4-2 computes, at 90, whether the light pattern includes a disturbance sequence.

If NO at 90:

At 91, the second controller 4-2 controls, the second light source 3-2 to emit light having a disturbance sequence light emission pattern for signaling a request for temporal capacity.

Generally, the disturbance sequence is used by agents to draw attention to communicate its request of more temporal capacity such that both agents have enough temporal space to simultaneously sense in the same space.

The disturbance sequence includes a temporal disturbance sequence light signal which blinds the other agents with a rapid flashing, e.g., spatially over the whole FOV.

In such cases, when A1 is trying to acquire event data, the event data may be of bad quality/not what was expected (e.g., too many events or driving up the event pixel potential to have little/no event).

Moreover, when A1 is checking for interference, there is an existing high event activity with not enough temporal capacity left for both agents to operate at the same time. This should trigger an “acknowledge” by stopping light emission.

If there is no response (no change in behavior of A2) after A1's “acknowledge”, agent A1 may move (if possible).

At 92, the second controller 4-2 controls the second light source 3-2 to stop emitting light and starts light activity detection.

At 93, the second controller 4-2 computes whether the light pattern has changed due to the disturbance sequence light emission pattern to another light pattern.

If NO at 93:

At 94, The second controller 4-2 computes that light emission adaption was not successful and moves to 61.

If YES at 93:

At 95, the second controller 4-2 computes whether the light pattern has vanished (e.g., as A1 is silent in response to the disturbance sequence light emission pattern of A2).

If YES at 95:

At 96 and 60 via 59, the second controller 4-2 controls the second light source 3-2 to emit light according to a default light emission pattern.

If NO at 95:

The second controller 4-2 returns to 81.

If YES at 90:

At 92, the second controller 4-2 starts again light activity detection.

At 93, the second controller 4-2 computes whether the light pattern has changed to another light pattern.

If NO at 93:

At 94, The second controller 4-2 computes that light emission adaption was not successful and moves to 61.

If YES at 93:

At 95, the second controller 4-2 computes whether the light pattern has vanished (e.g., as A1 is silent after its disturbance sequence light pattern).

If YES at 95:

At 96 and 60 via 59, the second controller 4-2 controls the second light source 3-2 to emit light according to a default light emission pattern.

If NO at 95:

The second controller 4-2 returns to 81.

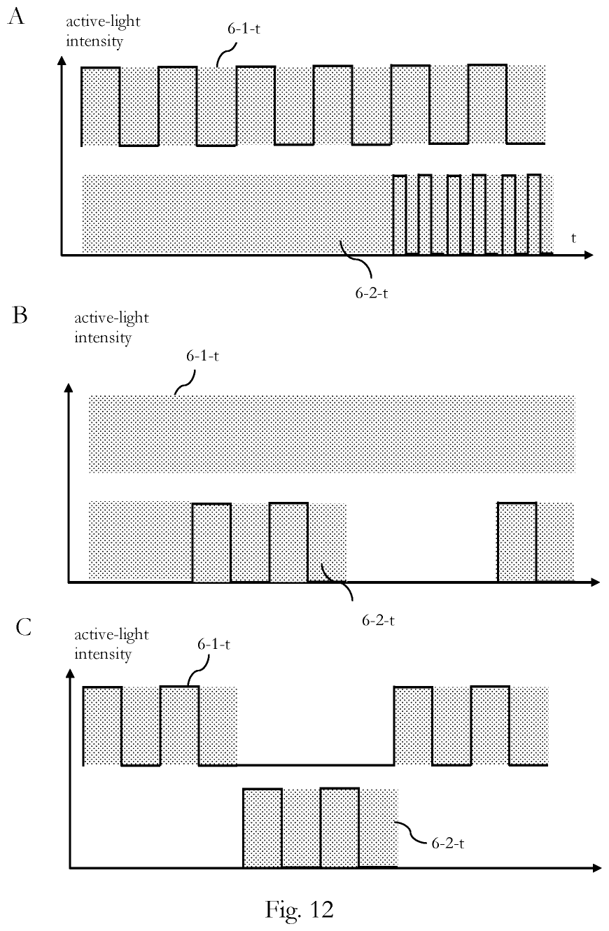

FIG. 12 schematically illustrates an embodiment an embodiment of computing a time-division light emission pattern, which is discussed in the following under reference of FIGS. 6, 8, 11 and 12.

In FIG. 12A, a first temporal intensity-modulated light signal 6-1-t is depicted which is emitted by the first light source 3-1 within the first FOI 6-1.

The first temporal intensity-modulated light signal 6-1-t utilizes a temporal capacity of 100%.

The second controller 4-2 simultaneously performs light activity detection with no light emission (as illustrated by 6-2-t) and detects, based on event data generated during light activity detection, that a light pattern according to the first temporal intensity-modulated light signal 6-1-t is present.

The second controller 4-2 further computes, at 81, that there is not enough temporal capacity left for sensing without interference, and that the light pattern does not include a disturbance sequence at 90.

Then, the second controller 4-2 controls the second light source 3-2 to emit a disturbance sequence light emission pattern (as illustrated by 6-2-t after the fourth light pulse of 6-1-t).

Then, the first agent A1 stops light emission as depicted in FIG. 12B in 6-1-t to acknowledge.

Additionally, the second controller 4-2 stops emitting light and starts light activity detection again to compute whether the light pattern has vanished.

Then, after some time, the second controller 4-2 computes that the light pattern has vanished and controls the second light source 3-2 to emit light according to a default light emission pattern (e.g., 50% temporal capacity).

Then, as illustrated in FIG. 12C, the first controller 4-1 controls the first light source 3-1 to emit light according to a time-division light pattern with respect to the default light emission pattern of the second agent A2.

Thereby, interference is avoided between the two agents A1 and A2.

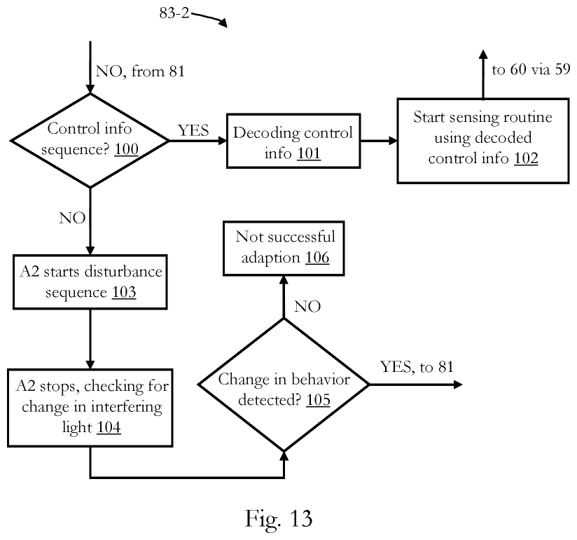

FIG. 13 schematically illustrates in a flow diagram an embodiment of computing a time-division light emission pattern according to a second communication protocol 83-2, which is discussed in the following under reference of FIGS. 6, 8 and 13.

If NO at 81:

At 100, the second controller 4-2 computes whether the light pattern includes control information about a current or next light pattern.

If YES at 100:

At 101, the second controller 4-2 decodes (obtains) the control information, wherein the control information include, for example, information about a current or next utilized temporal capacity.

At 102, the second controller 4-2 computes the time-division light emission pattern according to the obtained control information and controls the second light source 3-2 to emit light according to the computed time-division light emission pattern for avoiding interference.

If NO at 100:

The procedure at 103, 104, 105 and 106 is similar to the procedures at 91, 92, 93 and 94, respectively, and thus, it is referred to FIG. 11 to avoid unnecessary repetition.

However, if YES at 105, the second controller 4-2 returns to 81 (and not to 95 as at 93).

FIG. 14 schematically illustrates an embodiment of a light (emission) pattern 110 including control information, which is discussed in the following.

The first part of the light (emission) pattern 110 carries the control information.

The control information is encoded by a specific light pulse sequence which has varying pulse-widths, duty cycles and/or modulation frequencies to encode the control information. The encoding is known to both agents.

The control information encode, for example, a value for the temporal capacity utilized, e.g., in the next sensing sequence.

Generally, the control information may be used in addition to the disturbance sequence.

However, the first and second controller 4-1 and 4-2, respectively, must be able to distinguish control information, disturbance sequence and sensing sequence.

Nonetheless, this may provide a robust mode for the communication protocol.

In other embodiments, the control information replaces the disturbance sequence and, thus, only control information and sensing sequence must be distinguished.

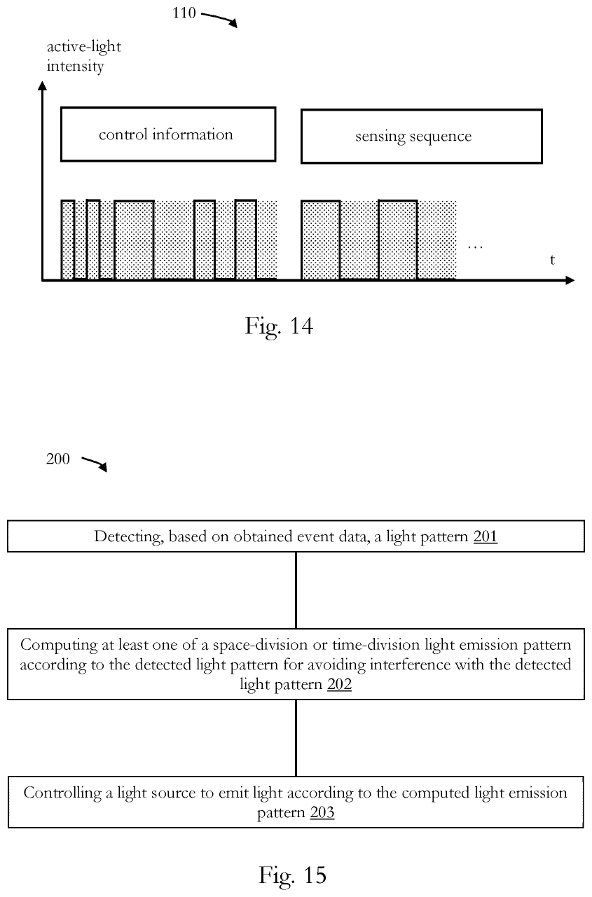

FIG. 15 schematically illustrates in a flow diagram an embodiment of a control method 200.

The control method may be performed by a control as described herein.

At 201, based on obtained event data, a light pattern is detected, as discussed herein.

At 202, at least one of a space-division or time-division light emission pattern is computed according to the detected light pattern for avoiding interference with the detected light pattern, as discussed herein.

At 203, a light source is controlled to emit light according to the computed light emission pattern, as discussed herein.

It should be recognized that the embodiments describe methods with an exemplary ordering of method steps. The specific ordering of method steps is however given for illustrative purposes only and should not be construed as binding.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.
(1) A controller for an event-based vision module, the event-based vision module including a light source configured to emit light according to a light emission pattern and an event-based vision sensor configured to acquire event data, wherein the controller includes circuitry configured to:
   detect, based on obtained event data, a light pattern;
   compute at least one of a space-division or time division light emission pattern according to the detected light pattern for avoiding interference with the detected light pattern; and
   control the light source to emit light according to the computed light emission pattern.
(2) The controller of (1), wherein the space-division light emission pattern lets the light source emit light in a space-divisional manner with respect to the detected light pattern.
(3) The controller of (1) or (2), wherein the time-division light emission pattern lets the light source emit light in a time-divisional manner with respect to the detected light pattern.
(4) The controller of anyone of (1) to (3), wherein the circuitry is configured to perform a communication protocol when a temporal capacity utilized by the detected light pattern is above a predetermined threshold.
(5) The controller of (4), wherein the communication protocol includes controlling the light source to emit light having a disturbance sequence light emission pattern for signaling a request for temporal capacity.
(6) The controller of (5), wherein the circuitry is configured to:
   control the light source to stop light emission after emitting the disturbance sequence light emission pattern; and
   start again, after controlling the light source to stop light emission, detection of the light pattern to compute whether the light pattern has changed to another light pattern or whether the light pattern has vanished.
(7) The controller anyone of (4) to (6), wherein the communication protocol includes computing whether the light pattern includes a disturbance sequence, and wherein the circuitry is configured to start again, when the light pattern includes a disturbance sequence, detection of the light pattern to compute whether the light pattern has changed to another light pattern or whether the light pattern has vanished.
(8) The controller of anyone of (1) to (7), wherein detected light pattern includes control information about a current or next light pattern, and wherein the circuitry is configured to obtain the control information and to compute the time-division light emission pattern according to the obtained control information.
(9) The controller of anyone of (1) to (8), wherein the circuitry is configured to control, when no light pattern is detected, the light source to emit light according to a default light emission pattern.
(10) The controller of anyone of (1) to (9), wherein the circuitry is configured to compute whether interference is inevitable and to output, in response thereto, an instruction to move the field-of-view.
(11) The controller of anyone of (1) to (10), wherein the circuitry is configured to regularly perform the detection of the light pattern.
(12) The controller of (11), wherein the circuitry is configured to control the light source to stop emitting light during the detection of the light pattern.
(13) The controller of (11) or (12), wherein the circuitry is configured to control a detection time interval on a random basis.
(14) The controller of anyone of (1) to (13), wherein the circuitry is configured to compute the light emission pattern further according to a preset strategy priority.
(15) The controller of anyone of (1) to (14), wherein the circuitry is configured to control the light source to increase an output power and to control the event-based vision sensor to increase plus and minus threshold values.
(16) The controller of anyone of (1) to (15), wherein the circuitry is configured to control the event-based vision sensor to adapt a low-pass filter frequency to be lower than a modulation frequency of the light pattern.
(17) The controller of (16), wherein the circuitry is configured to control the light source to use a modulation frequency for the light emission pattern that is lower than the low-pass filter frequency.
(18) The controller of anyone of (1) to (17), wherein the circuitry is configured to detect the light pattern further based on a change in latency of an event-response timing.
(19) A control method for an event-based vision module, the event-based vision module including a light source configured to emit light according to a light emission pattern and an event-based vision sensor configured to acquire event data, wherein the control method includes:
   detecting, based on obtained event data, a light pattern;
   computing at least one of a space-division or time division light emission pattern according to the detected light pattern for avoiding interference with the detected light pattern; and
   controlling the light source to emit light according to the computed light emission pattern.
(20) An event-based vision module, including:
   a light source configured to emit light according to a light emission pattern;
   an event-based vision sensor configured to acquire event data; and
   a controller including circuitry configured to:
      detect, based on obtained event data, a light pattern,
      compute at least one of a space-division or time division light emission pattern according to the detected light pattern for avoiding interference with the detected light pattern,
      control the light source to emit light according to the computed light emission pattern.
(21) A computer program comprising program code causing a computer to perform the method according to (19), when being carried out on a computer.
(22) A non-transitory computer-readable recording medium that stores therein a computer program product, which, when executed by a processor, causes the method according to (19) to be performed.

1. A controller for an event-based vision module, the event-based vision module including a light source configured to emit light according to a light emission pattern and an event-based vision sensor configured to acquire event data, wherein the controller comprises circuitry configured to:
detect, based on obtained event data, a light pattern;
compute at least one of a space-division or time division light emission pattern according to the detected light pattern for avoiding interference with the detected light pattern; and
control the light source to emit light according to the computed light emission pattern.

2. The controller according to claim 1, wherein the space-division light emission pattern lets the light source emit light in a space-divisional manner with respect to the detected light pattern.

3. The controller according to claim 1, wherein the time-division light emission pattern lets the light source emit light in a time-divisional manner with respect to the detected light pattern.

4. The controller according to claim 1, wherein the circuitry is configured to perform a communication protocol when a temporal capacity utilized by the detected light pattern is above a predetermined threshold.

5. The controller according to claim 4, wherein the communication protocol includes controlling the light source to emit light having a disturbance sequence light emission pattern for signaling a request for temporal capacity.

6. The controller according to claim 5, wherein the circuitry is configured to:
control the light source to stop light emission after emitting the disturbance sequence light emission pattern; and
start again, after controlling the light source to stop light emission, detection of the light pattern to compute whether the light pattern has changed to another light pattern or whether the light pattern has vanished.

7. The controller according to claim 4, wherein the communication protocol includes computing whether the light pattern includes a disturbance sequence, and wherein the circuitry is configured to start again, when the light pattern includes a disturbance sequence, detection of the light pattern to compute whether the light pattern has changed to another light pattern or whether the light pattern has vanished.

8. The controller according to claim 1, wherein detected light pattern includes control information about a current or next light pattern, and wherein the circuitry is configured to obtain the control information and to compute the time-division light emission pattern according to the obtained control information.

9. The controller according to claim 1, wherein the circuitry is configured to control, when no light pattern is detected, the light source to emit light according to a default light emission pattern.

10. The controller according to claim 1, wherein the circuitry is configured to compute whether interference is inevitable and to output, in response thereto, an instruction to move the field-of-view.

11. The controller according to claim 1, wherein the circuitry is configured to regularly perform the detection of the light pattern.

12. The controller according to claim 11, wherein the circuitry is configured to control the light source to stop emitting light during the detection of the light pattern.

13. The controller according to claim 11, wherein the circuitry is configured to control a detection time interval on a random basis.

14. The controller according to claim 1, wherein the circuitry is configured to compute the light emission pattern further according to a preset strategy priority.

15. The controller according to claim 1, wherein the circuitry is configured to control the light source to increase an output power and to control the event-based vision sensor to increase plus and minus threshold values.

16. The controller according to claim 1, wherein the circuitry is configured to control the event-based vision sensor to adapt a low-pass filter frequency to be lower than a modulation frequency of the light pattern.

17. The controller according to claim 16, wherein the circuitry is configured to control the light source to use a modulation frequency for the light emission pattern that is lower than the low-pass filter frequency.

18. The controller according to claim 1, wherein the circuitry is configured to detect the light pattern further based on a change in latency of an event-response timing.

19. A control method for an event-based vision module, the event-based vision module including a light source configured to emit light according to a light emission pattern and an event-based vision sensor configured to acquire event data, wherein the control method comprises:
detecting, based on obtained event data, a light pattern;
computing at least one of a space-division or time division light emission pattern according to the detected light pattern for avoiding interference with the detected light pattern; and
controlling the light source to emit light according to the computed light emission pattern.

20. An event-based vision module, comprising:
a light source configured to emit light according to a light emission pattern;
an event-based vision sensor configured to acquire event data; and
a controller including circuitry configured to:
detect, based on obtained event data, a light pattern,
compute at least one of a space-division or time division light emission pattern according to the detected light pattern for avoiding interference with the detected light pattern,
control the light source to emit light according to the computed light emission pattern.
